(19) United States
(12) Patent Application Publication
(10) Pub. No.: US 2011/0028634 A1
(43) Pub. Date: Feb. 3, 2011

(54) POLYCARBONATE RESIN COMPOSITION, MOLDED POLYCARBONATE RESIN, AND PROCESS FOR PRODUCING THE SAME

(75) Inventors: Toshio Isozaki, Chiba (JP); Kouji Satou, Chiba (JP); Takayoshi Tanaka, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co., Ltd., Tokyo (JP)

(21) Appl. No.: 12/745,170

(22) PCT Filed: Oct. 31, 2008
(86) PCT No.: PCT/JP08/69889

§ 371 Date: Oct. 18, 2010

(30) Foreign Application Priority Data
Nov. 29, 2007 (JP) 2007-309327

(51) Int. Cl. C08K 3/40; B29C 45/00

(52) U.S. Cl. 524/494; 524/588; 264/328.1

(57) ABSTRACT

Provided are a polycarbonate resin composition which includes a specific amount of a glass filler and a specific amount of a glossy particle and is excellent in optical characteristics and flame retardancy, and in which difference in brightness between a left half and a right half of a weld line of a molded product is not visually observed, a polycarbonate resin molded article, and a method for producing the polycarbonate resin molded article. The polycarbonate resin composition includes, with respect to 100 parts by mass of a composition composed of (A) more than 90 parts by mass and 99 parts by mass or less of an aromatic polycarbonate resin containing 10 to 40 parts by mass of a polycarbonate-polyorganosiloxane copolymerized resin and (B) 1 part by mass or more and less than 10 parts by mass of a glass filler having a difference in a refractive index of 0.002 or less from the aromatic polycarbonate resin, (C) 0.01 to 3.0 parts by mass of a glossy particle and (D) 0.05 to 2.0 parts by mass of a silicone compound having a reactive functional group.

### TECHNICAL FIELD

The present invention relates to a polycarbonate resin composition, a polycarbonate resin molded article using the composition, and a method for producing the molded article, and more specifically, to a polycarbonate resin composition containing a glass filler, which is excellent in galactic appearance (glittering pattern like the night sky studded with stars), metallic appearance, and provided with high flame retardancy, a polycarbonate resin molded article obtained by molding the resin composition, and a method for producing the molded article.

### BACKGROUND ART

Polycarbonate resin molded articles have been widely used as, for example, industrial transparent materials in the fields of electrical and electronic engineering, mechanical engineering, automobiles, and the like or optical materials for lenses, optical disks, and the like because each of the articles is excellent in transparency and mechanical strength. When an additionally high mechanical strength is needed, a glass filler or the like is added to each of the articles to strengthen the article.

Glass fibers each constituted of glass generally called an E glass have been used as the glass filler. However, the refractive index of the E glass at a sodium D line (nD, hereinafter, simply referred to as “refractive index”) is somewhat small, specifically, about 1.555, though the refractive index of a polycarbonate resin is 1.580 to 1.590. Accordingly, when the glass filler is added to a polycarbonate resin composition in an amount needed for an increase in mechanical strength of the composition, the following problem arises: the resultant E glass-reinforced polycarbonate resin composition cannot maintain its transparency owing to a difference in refractive index between the filler and the polycarbonate resin of which the composition is formed, with the result that when the resin to which glossy particles are added in order that a metallic appearance or galactic appearance may be obtained is not the transparent resin, only the glossy particles near the surface of a molded article are seen, so neither a metallic appearance nor a galactic appearance can be obtained.

To solve such problem, investigation has been conducted on, for example, a reduction in refractive index of a polycarbonate resin by the improvement of the resin or an increase in refractive index of a glass filler by the improvement of the composition of the glass filler.

For example, (1) a resin composition containing a polycarbonate resin composition using a product of a reaction between a hydroxyaralkyl alcohol and lactone as a terminating agent and a glass filler having difference in a refractive index of 0.01 or less from the polycarbonate resin composition (see Patent Document 1), (2) a resin composition composed of a polycarbonate resin, a glass filler having difference in a refractive index of 0.015 or lessfrom the polycarbonate resin, and polycaprolactone (see Patent Document 2), and (3) a glass composition obtained by incorporating, for example, ZrO₂, TiO₂, BaO, and ZnO into a glass filler composition at a specific ratio so that the refractive index of the composition is close to that of a polycarbonate resin (see Patent Document 3) have been proposed.

However, the resin composition in the above Patent Document 1 is not practical because of the following reasons: when the glass filler is added in an amount needed for an increase in dimensional stability and mechanical strength of the composition, the difference in refractive index at such level is not small enough for the addition to exert its effect, and the glass filler is too expensive to be used as a raw material for the production of the polycarbonate resin composition.

The polycarbonate resin composition in the above Patent Document 2 involves the following problem: reductions in heat resistance and mechanical properties of the composition are inevitable owing to the presence of polycaprolactone which has a low softening temperature and is added to decrease the refractive index, though the composition can maintain its transparency even when the glass filler has difference in a refractive index of 0.015 or less from the polycarbonate resin.

Unless the content of each of, for example, ZrO₂, TiO₂, BaO, and ZnO in the glass composition in the above Patent Document 3 is appropriately adjusted, the glass filler itself will devitrify. As a result, even when the glass filler has a refractive index almost equal to that of the polycarbonate resin, a polycarbonate resin composition containing the glass filler may be unable to obtain transparency. In addition, the significance of the use of a glass filler-reinforced polycarbonate resin composition for the purpose of a weight reduction lowers because the specific gravity of the glass filler itself increases. In addition, none of the Patent Documents 1 to 3 make any mention of the problem of the decrease in the weld line and alignment of the glossy particles.

Further, in the case of a polycarbonate resin composition containing glossy particles, when the resin composition is molded, a weld line is formed at a part where molten resin compositions are merged into and welded to each other, and as a result, difference in brightness between the left half and the right half of the weld line is caused.

The phenomenon is described below by using FIG. 1.

In the case where the glass filler is not contained in the resin composition, as shown in FIG. 1—(1), when the molten resin compositions are merged into each other and the weld line is formed at the central part, the glossy particles which are added thereto in order to provide the resin composition with a metallic appearance or a galactic appearance are in a standing (aligned) state without falling flat in the vicinity of the weld line. As a result of this phenomenon, light reflection by the glossy particles is scattered, and accordingly, the vicinity of the weld line becomes dark.

When the phenomenon is exhibited, a commercial value of a resin molded article lowers, and hence various countermeasures to prevent the phenomenon have been proposed.

For example, as the glossy particles, there have been proposed: (4) a resin composition containing a particle having a shape in which an average particle diameter is 10 to 300 μm and an aspect ratio is 1/8 to 1 (see Patent Document 4); and (5) a resin composition containing a fine metal particle which is in a square shape with a notch at one corner (see Patent Document 5). In those glossy particles, it has been suggested that the shapes of the glossy particles themselves can prevent formation of the weld line and have an effect of decreasing alignment of the glossy particles.

However, in Patent Documents 4 and 5, there is no description about the case of adding a glass filler to the resin composition, and, as might be expected, there is no description that the alignment of the glossy particles can be decreased by the glass filler. In addition, there is no description on flame retardancy of the resin composition, and the fields in which the resin composition can be used are limited when flame retardancy is not imparted thereto.

It is to be noted that (6) a glass filler-reinforced polycarbonate resin composition having a metallic appearance (see Patent Document 6) has been also proposed, but in this case, there is no description on an issue of decreasing the alignment of the glossy particles on the weld line. In addition, there is no description on flame retardancy of the glass filler-reinforced polycarbonate resin composition, and the fields in which the glass filler-reinforced polycarbonate resin composition can be used are limited when the flame retardancy is not imparted thereto.

Further, there has been disclosed (7) a molded product in which amorphous polymer particles are attached to flaky fine particles by performing precipitation polymerization of an amorphous polymer in the presence of glossy flaky fine particles in order not to cause appearances defects such as a weld line, a weld dichroism, and the like (see Patent Document 7).

Still further, there has been proposed (8) a polycarbonate resin composition, in which a refractive index is improved by adding thereto a polycarbonate resin and a specific glass to which oxides of various metals are added, and which has difference in a refractive index of 0.001 or less from the polycarbonate resin (see Patent Document 8).

However, in the case of Patent Document 7, it is only AAS resin that is specifically described as the amorphous polymer in examples and comparative examples, and there is no description about the polycarbonate resin. In addition, there is no description about the case of adding a glass filler to the polycarbonate resin, and, as might be expected, there is no description that the alignment of the glossy particles can be decreased by the glass filler. There is also no description on flame retardancy of the polycarbonate resin, and the fields in which the polycarbonate resin can be used are limited when flame retardancy is not imparted thereto. In the polycarbonate resin composition of Patent Document 8, there is no description on an issue of decreasing the alignment of the glossy particles on the weld line, and in addition, there is no reference to flame retardancy of the polycarbonate resin composition, and the fields in which the polycarbonate resin composition can be used are limited when flame retardancy is not imparted thereto.

Patent Document 1: JP 07-118514 A

Patent Document 2: JP 09-165506 A

Patent Document 3: JP 05-155638 A

Patent Document 4: JP 06-99594 A

Patent Document 5: JP 07-53768 A

Patent Document 6: JP 06-212068 A

Patent Document 7: JP 2001-262003 A

Patent Document 8: JP 2006-022236 A

### DISCLOSURE OF THE INVENTION

### Problems to be Solved by the Invention

The present invention has, under the above-mentioned circumstances, an object to provide: a polycarbonate resin composition in which, by allowing the polycarbonate resin composition to contain a specific amount of a limited glass filler, difference in brightness between the left half and the right half of a weld line is not visually observed, a good metallic appearance or a galactic appearance is obtained, strength and heat resistance are excellent, and high flame retardancy is provided; a polycarbonate resin molded article formed by molding the resin composition; and a method for producing the polycarbonate resin molded article.

### Means for Solving the Problems

The inventors of the present invention have intensively studied to achieve the above-mentioned object, and as a result, they have found that the present invention can be achieved by: a polycarbonate resin composition having excellent flame retardancy, which includes an aromatic polycarbonate resin containing a polycarbonate-polyorganosiloxane copolymer resin and a specific amount of glossy particles, and which also includes, at a predetermined ratio, each of a glass filler having a difference in a refractive index of 0.002 or less from the resin, whose blending amount is the specific amount with respect to that of the resin, and a silicone compound having a reactive functional group; and a polycarbonate resin molded article formed by molding the resin composition. The present invention has been accomplished based on those findings.

That is, the present invention provides:

(1) a polycarbonate resin composition including, with respect to 100 parts by mass of a composition composed of (A) more than 90 parts by mass and 99 parts by mass or less of an aromatic polycarbonate resin containing a polycarbonate-polyorganosiloxane copolymer and (B) 1 part by mass or more and less than 10 parts by mass of a glass filler having a difference in a refractive index of 0.002 or less from the aromatic polycarbonate resin, (C) 0.01 to 3.0 parts by mass of a glossy particle and (D) 0.05 to 2.0 parts by mass of a silicone compound having a reactive functional group;

(2) the polycarbonate resin composition according to the item (1), in which the aromatic polycarbonate resin as the component (A) includes 10 to 40 parts by mass of the polycarbonate-polyorganosiloxane copolymer;

(3) the polycarbonate resin composition according to the item (1), in which the polycarbonate-polyorganosiloxane copolymer includes a polyorganosiloxane moiety at a ratio of 0.3 to 5.0% by mass;

(4) the polycarbonate resin composition according to the item (1), in which the glass filler as the component (B) includes a glass fiber;

(5) the polycarbonate resin composition according to the item (1), in which the refractive index of the glass filler as the component (B) is 1.583 to 1.587;

(6) the polycarbonate resin composition according to the item (1), in which the glossy particle as the component (C) includes one or two or more kinds selected from the group consisting of mica, metal particles, metal sulfide particles, particles each having a surface coated with a metal or a metal oxide, and glass flakes each having a surface coated with a metal or a metal oxide;

(7) the polycarbonate resin composition according to the item (1), further including (E) 0.0001 to 1 part by mass of a colorant with respect to 100 parts by mass of the composition composed of the component (A) and the component (B);

(8) a polycarbonate resin molded article obtained by molding the polycarbonate resin composition according to the item (1);

(9) the polycarbonate resin molded article according to the item (8), in which the polycarbonate resin molded article is obtained by injection molding at a mold temperature of 120° C. or higher;

(10) the polycarbonate resin molded article according to the item (8), in which the polycarbonate resin molded article has a flame retardancy determined by a flame retardancy evaluation method in conformance with UL94 of 1.5 mmV-0;

(11) the polycarbonate resin molded article according to the item (8), in which the glass filler contained in a pellet of the polycarbonate resin composition or in a molded article of the polycarbonate resin composition has an average length of 300 μm or more; and

(12) a method for producing a polycarbonate resin molded article, including subjecting the polycarbonate resin composition according to the item (1) to injection molding at a mold temperature of 120° C. or higher.

### EFFECTS BY THE INVENTION

According to the present invention, there are provided the polycarbonate resin composition which is excellent in transparency, strength, and heat resistance, and provided with high flame retardancy, and the polycarbonate resin molded article having an excellent galactic appearance or metallic appearance. Further, there is provided the method for producing the polycarbonate resin molded article having an excellent galactic appearance or metallic appearance.

### BRIEF DESCRIPTION OF THE DRAWINGS

FIG. 1 is views each illustrating a state of glossy particles at a left half and a right half of a weld line, the state being changed depending on presence or absence of glass fillers.

### BEST MODE FOR CARRYING OUT THE INVENTION

A polycarbonate resin (hereinafter, occasionally abbreviated as PC resin) composition of the present invention is characterized by including, with respect to 100 parts by mass of a composition composed of (A) more than 90 parts by mass and 99 parts by mass or less of an aromatic polycarbonate resin containing a polycarbonate-polyorganosiloxane copolymer and (B) 1 part by mass or more and less than 10 parts by mass of a glass filler having a difference in a refractive index of 0.002 or less from the aromatic polycarbonate resin, (C) 0.01 to 3.0 parts by mass of a glossy particle and (D) 0.05 to 2.0 parts by mass of a silicone compound having a reactive functional group, and, if required, (E) 0.0001 to 3 parts by mass of a colorant may be added thereto.

The PC resin composition of the present invention has a flame retardancy determined by a flame retardancy evaluation method in conformance with UL94 of 1.5 mmV-0.

In the PC resin composition of the present invention, an aromatic polycarbonate resin containing a polycarbonate-polyorganosiloxane copolymer (hereinafter, occasionally abbreviated as PC-POS copolymer) is used as the aromatic PC resin serving as the component (A).

Specifically, the aromatic PC resin containing (a-1) an aromatic PC resin (hereinafter, occasionally abbreviated as general PC resin) produced by a reaction between a dihydric phenol and a carbonate precursor and (a-2) a PC-POS copolymer, in which the content of the PC-POS copolymer is 10 to 40 parts by mass, is preferably used.

When the content of the PC-POS copolymer as the component (a-2) in the aromatic polycarbonate resin as the component (A) is 10 parts by mass or more, a PC resin composition having excellent rigidity can be obtained, and on the other hand, when the content is 40 parts by mass or less, a PC resin composition whose specific gravity is not too large and which has good impact resistance can be obtained.

A method for producing the general PC resin as the component (a-1) of the component (A) is not particularly limited, and resins produced by various conventional methods can each be used as the PC resin. For example, a resin produced from a dihydric phenol and a carbonate precursor by a solution method (interfacial polycondensation method) or a melt method (transesterification method), that is, a resin produced by, for example, an interfacial polycondensation method involving causing the dihydric phenol and phosgene to react with each other in the presence of a terminating agent or a transesterification method involving causing the dihydric phenol and diphenyl carbonate or the like to react with each other in the presence of a terminating agent can be used.

As the dihydric phenol, various examples are given. In particular, examples thereof include 2,2-bis(4-hydroxyphenyl)propane [bisphenol A], bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cycloalkane, bis(4-hydroxyphenyl)oxide, bis(4-hydroxyphenyl)sulfide, bis(4-hydroxyphenyl)sulfone, bis(4-hydroxyphenyl)sulfoxide, and bis(4-hydroxyphenyl)ketone. In addition, hydroquinone, resorcin, and catechol can be also exemplified. One kind of those dihydric phenols may be used alone, or two or more kinds thereof may be used in combination. Of those, bis(hydroxyphenyl)alkanes are preferred, and bisphenol A is particularly preferred.

On the other hand, as the carbonate precursor, a carbonyl halide, carbonyl ester, or a haloformate, and the like are given. Specifically, phosgene, dihaloformate of a dihydric phenol, diphenyl carbonate, dimethyl carbonate, and diethyl carbonate are given.

It is to be noted that the aromatic PC resin may have a branched structure. As a branching agent, 1,1,1-tris(4-hydroxyphenyl)ethane, α,α′,α″-tris(4-hydroxyphenyl)-1,3,5-triisopropylbenzene, phloroglycine, trimellitic acid, isatinbis(o-cresol), and the like are exemplified.

In the present invention, a viscosity average molecular weight (Mv) of the general PC resin used as (a-1) component is generally 10,000 to 50,000, preferably 13,000 to 35,000, and more preferably 15,000 to 20,000.

The viscosity average molecular weight (Mv) is calculated by the following equation, after a limiting viscosity [η] is obtained by determining a viscosity of methylene chloride solution at 20° C. by using a Ubbelohde type viscometer.

[η]=1.23×10⁻⁵ Mv^{0.83}

In the aromatic polycarbonate resin as the component (A), the PC-POS copolymer used as the component (a-2) is composed of a polycarbonate moiety and a polyorganosiloxane moiety, which can be produced by, for example: dissolving a polycarbonate oligomer (hereinafter, abbreviated as a PC oligomer), which forms the polycarbonate moiety, and a polyorganosiloxane having, at an end thereof, a reactive group such as an o-allylphenol residue, a p-hydroxystyrene residue, or an eugenol group, which forms the polyorganosiloxane moiety (segment), those of which have been produced in advance, in a solvent such as methylene chloride, chlorobenzene, or chloroform; adding an aqueous caustic alkali solution of a dihydric phenol to the resultant solution; and performing an interfacial polycondensation reaction under the presence of an terminating agent by using, as a catalyst, a tertiary amine (e.g., triethylamine), a quaternary ammonium salt (e.g., trimethylbenzyl ammonium chloride), or the like.

The PC oligomer used for producing the PC-POS copolymer can be readily produced by, for example, reacting the dihydric phenol with a carbonate precursor such as phosgene in a solvent such as methylene chloride, or by reacting the dihydric phenol with a carbonate precursor such as a carbonate compound e.g., diphenyl carbonate, in a solvent such as methylene chloride.

Further, examples of the carbonate compounds include diarylcarbonates such as diphenylcarbonate and dialkylcarbonates such as dimethylcarbonate and diethylcarbonate.

The PC oligomer used for producing the PC-POS copolymer may be a homooligomer in which one kind of the dihydric phenols is used, or may be a cooligomer in which two or more kinds thereof are used.

Further, the PC oligomer may also be a thermoplastic random branched oligomer obtained by using a polyfunctional aromatic compound and the dihydric phenol in combination.

In such a case, examples of the branching agent (polyfunctional aromatic compound) to be used include 1,1,1-tris(4-hydroxyphenyl)ethane, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benzene, phloroglycine, trimellitic acid, and isatinbis(o-cresol).

The PC-POS copolymer is disclosed in, for example, JP 03-292359 A, JP 04-202465 A, JP 08-81620 A, JP 08-302178 A, JP 10-7897 A, and the like.

As the PC-POS copolymer, it is preferred that a polymerization degree of the polycarbonate moiety is about 3 to 100 and a polymerization degree of the polyorganosiloxane moiety be about 2 to 500.

Further, a content of the polyorganosiloxane moiety in the PC-POS copolymer is, from the viewpoints of flame retardancy-imparting effect, economy balance, and the like to the PC resin composition to be obtained, 0.3 to 5.0% by mass and more preferably 0.5 to 4.0% by mass.

In addition, a viscosity average molecular weight (Mv) of the PC-POS copolymer is generally 5,000 to 100,000, preferably 10,000 to 30,000, and particularly preferably 12,000 to 30,000.

Herein, those viscosity average molecular weights (Mv) can be measured in the same manner as those of the general PC resin.

As the polyorganosiloxane moiety contained in the PC-POS copolymer, preferred is a segment formed of polydimethylsiloxane, polydiethylsiloxane, polymethylphenylsiloxane, or the like, and particularly preferred is a polydimethylsiloxane segment.

A molecular terminal group in the aromatic PC resin as the component (A) is not particularly limited, and a monovalent, phenol-derived group as a conventionally known terminating agent may be used; a monovalent, phenol-derived group having an alkyl group having 10 to 35 carbon atoms is preferred. When the molecular terminal is a phenol-derived group having an alkyl group having 10 or more carbon atoms, a PC resin composition to be obtained has good flowability. In addition, when the molecular terminal is a phenol-derived group having an alkyl group having 35 or less carbon atoms, the PC resin composition to be obtained has good heat resistance and good impact resistance.

Examples of the monovalent phenol having an alkyl group having 10 to 35 carbon atoms include decyl phenol, undecyl phenol, dodecyl phenol, tridecyl phenol, tetradecyl phenol, pentadecyl phenol, hexadecyl phenol, heptadecyl phenol, octadecyl phenol, nonadecyl phenol, icosyl phenol, docosyl phenol, tetracosyl phenol, hexacosyl phenol, octacosyl phenol, triacontyl phenol, dotriacontyl phenol, and pentatriacontyl phenol.

The alkyl group may be present at any one of the o-, m-, and p-positions of each of those alkyl phenols with respect to the hydroxyl group; the alkyl group is preferably present at the p-position. In addition, the alkyl group may be a linear group, a branched group, or a mixture of them.

At least one substituent of each of the alkyl phenols has only to be the alkyl group having 10 to 35 carbon atoms, and the other four substituents are not particularly limited; each of the other four substituents may be an alkyl group having 1 to 9 carbon atoms, an aryl group having 6 to 20 carbon atoms, or a halogen atom, or each of the alkyl phenols may be unsubstituted except for the hydroxyl group and the alkyl group having 10 to 35 carbon atoms.

Only one of the terminals in the PC resin may be terminated with a monovalent phenol having the alkyl group having 10 to 35 carbon atoms, or each of both the terminals may be terminated with the phenol. In addition, terminals each denatured with the phenol account for preferably 20% or more, or more preferably 50% or more of all terminals from the viewpoint of an improvement in flowability of the PC resin composition to be obtained. That is, the other terminals none of which is terminated with the phenol may each be terminated with a hydroxyl group terminal or any one of the other terminating agents in the following description.

Herein, examples of the other terminating agents include phenol, p-cresol, p-tert-butylphenol, p-tert-octylphenol, p-cumylphenol, p-nonylphenol, p-tert-amylphenol, bromophenol, tribromophenol, and pentabromophenol, which are commonly used in the production of the aromatic PC resin. Of those, a halogen-free compound is preferred in view of environmental issues.

In the PC resin composition of the present invention, the aromatic PC resin as the component (A) can appropriately contain, in addition to the PC resin, a copolymer resin such as a polyester-polycarbonate resin obtained by polymerizing polycarbonate in the presence of an ester precursor such as a bifunctional carboxylic acid such as terephthalic acid or an ester-forming derivative of the acid, or any other polycarbonate resin to such an extent that the object of the present invention is not impaired.

In the PC resin composition of the present invention, it is required that the glass filler used as the component (B) has a difference in a refractive index of 0.002 or less from the aromatic PC resin (A), and that, with respect to 100 parts by mass of a composition composed of the PC resin and the glass filler, the content of the aromatic PC resin is more than 90 parts by mass and 99 parts by mass or less and the content of the glass filler is 1 part by mass or more and less than 10 parts by mass.

When a difference in a refractive index from the aromatic PC resin is more than 0.002, the galactic or metallic appearance of the molded article obtained by using the PC resin composition becomes insufficient. The difference in refractive is preferably 0.001 or less, and in particular, it is preferred that the refractive index of the glass filler be the same as that of the aromatic PC resin used as the component (A). As such a glass filler, it is preferred to use a glass filler having a refractive index of 1.583 to 1.587.

Glass of which such glass filler is constituted is, for example, a “glass I” or “glass II” having the following composition.

It is preferred that the “glass I” contain 50 to 60% by mass of silicon oxide (SiO₂), 10 to 15% by mass of aluminum oxide (Al₂O₃), 15 to 25% by mass of calcium oxide (CaO), 2 to 10% by mass of titanium oxide (TiO₂), 2 to 8% by mass of boron oxide (B₂O₃), 0 to 5% by mass of magnesium oxide (MgO), 0 to 5% by mass of zinc oxide (ZnO), 0 to 5% by mass of barium oxide (BaO), 0 to 5% by mass of zirconium oxide (ZrO₂), 0 to 2% by mass of lithium oxide (LiO₂), 0 to 2% by mass of sodium oxide (Na₂O), and 0 to 2% by mass of potassium oxide (K₂O), and have a total content of the lithium oxide (LiO₂), the sodium oxide (Na₂O), and the potassium oxide (K₂O) of 0 to 2% by mass.

On the other hand, it is preferred that the “glass II” contain 50 to 60% by mass of silicon oxide (SiO₂), 10 to 15% by mass of aluminum oxide (Al₂O₃), 15 to 25% by mass of calcium oxide (CaO), 2 to 5% by mass of titanium oxide (TiO₂), 0 to 5% by mass of magnesium oxide (MgO), 0 to 5% by mass of zinc oxide (ZnO), 0 to 5% by mass of barium oxide (BaO), 2 to 5% by mass of zirconium oxide (ZrO₂), 0 to 2% by mass of lithium oxide (LiO₂), 0 to 2% by mass of sodium oxide (Na₂O), and 0 to 2% by mass of potassium oxide (K₂O), be substantially free of boron oxide (B₂O₃), and have a total content of the lithium oxide (LiO₂), the sodium oxide (Na₂O), and the potassium oxide (K₂O) of 0 to 2% by mass.

The content of SiO₂ in each of the “glasses I and II” is preferably 50 to 60% by mass from the viewpoints of the strength of the glass filler and solubility at the time of the production of each of the glass. The content of Al₂O₃ is preferably 10 to 15% by mass from the viewpoints of the chemical durability of each of the glass such as water resistance and solubility at the time of the production of each of the glass. The content of CaO is preferably 15 to 25% by mass from the viewpoints of solubility at the time of the production of each of the glass and the suppression of the crystallization of each of the glass.

The “glass I” can contain 2 to 8% by mass of B₂O₃ like the E glass. In this case, the content of TiO₂ is preferably 2 to 10% by mass from the viewpoints of, for example, an improving effect on the refractive index of the glass and the suppression of the devitrification of the glass.

In addition, it is preferred that the “glass II” be substantially free of B₂O₃ like ECR glass composition, which is excellent in acid resistance and alkali resistance. In this case, the content of TiO₂ is preferably 2 to 5% by mass from the viewpoint of the adjustment of the refractive index of the glass. In addition, the content of ZrO₂ is preferably 2 to 5% by mass from the viewpoints of an increase in refractive index of the glass, an improvement in chemical durability of the glass, and solubility at the time of the production of the glass.

In each of the “glasses I and II”, MgO is an optional component, and can be incorporated at a content of about 0 to 5% by mass from the viewpoints of an improvement in durability of each of the glass such as a tensile strength and solubility at the time of the production of each of the glass. In addition, ZnO and BaO are also optional components, and each of them can be incorporated at a content of about 0 to 5% by mass from the viewpoints of an increase in refractive index of each of the glass and the suppression of the devitrification of each of the glass.

In the “glass I”, ZrO₂ is an optional component, and can be incorporated at a content of about 0 to 5% by mass from the viewpoints of an increase in refractive index of the glass and solubility at the time of the production of the glass.

In each of the “glasses I and II”, Li₂O, Na₂O, and K₂O as alkali components are optional components, and each of them can be incorporated at a content of about 0 to 2% by mass. In addition, the total content of the alkali components is preferably 0 to 2% by mass. When the total content is 2% by mass or less, a reduction in water resistance of each of the glass can be suppressed.

As described above, each of the “glasses I and II” contains a small amount of alkali components, and hence a reduction in molecular weight of the PC resin composition due to the decomposition of the aromatic PC resin as the component (A) can be suppressed, and reductions in physical properties of an article molded out of the PC resin composition can be prevented.

Each of the “glasses I and II” may contain, in addition to the glass components, for example, an oxide containing an element such as lanthanum (La), yttrium (Y), gadolinium (Gd), bismuth (Bi), antimony (Sb), tantalum (Ta), niobium (Nb), or tungsten (W) as a component for increasing the refractive index of the glass to such an extent that the spinning property, water resistance, and the like of the glass are not adversely affected. In addition, each of the glass may contain an oxide containing an element such as cobalt (Co), copper (Cu), or neodymium (Nd) as a component for masking the yellow color of the glass.

In addition, the content of Fe₂O₃ as an impurity on an oxide basis in the glass raw materials to be used in the production of each of the “glasses I and II” is preferably less than 0.01% by mass with respect to the entirety of the glass in order that the discoloration in the glass may be suppressed.

The glass filler as the component (B) in the PC resin composition of the present invention can be obtained by: appropriately choosing a glass having difference in a refractive index of 0.002 from the aromatic PC resin as the component (A) from the “glasses I and II” each having the above-mentioned glass composition; and forming the chosen glass into a desired shape. A form of the glass filler is not particularly limited, and in order to decrease difference in brightness between the left half and the right half of the weld line to an extent that the difference in brightness cannot be visually observed, the glass filler contained in a pellet of the PC resin composition or in a molded article of the PC resin composition has an average fiber length of 300 μm or more, and from this viewpoint, a glass fiber is suitable.

The glass fibers can be obtained by employing a conventionally known spinning method for long glass fibers. For example, glass can be turned into fibers by employing any one of the various methods such as: a direct melting (DM) method involving continuously turning glass raw materials into glass in a melting furnace, introducing the resultant glass into a forehearth, and attaching a bushing to the bottom of the forehearth to spin the glass; and a remelting method involving processing molten glass into a marble-, cullet-, or rod-like shape, remelting the resultant, and spinning the resultant.

Although the diameter of each of the glass fibers is not particularly limited, fibers each having a diameter of about 3 to 25 μm are preferably used in ordinary cases. When the diameter is 3 μm or more, diffuse reflection is suppressed, whereby a reduction in galactic appearance or metallic appearance can be prevented. In addition, when the diameter is 25 μm or less, the molded article to be obtained has a good strength.

As described above, the average length of the glass fibers contained in a pellet of the PC resin composition or in a molded article of the PC resin composition is 300 μm or more and preferably 350 μm or more. When the average length of the glass fibers is less than 300 μm, a tendency becomes apparent, that an effect of decreasing difference in brightness between the left half and the right half of the weld line becomes difficult to be obtained. It is to be noted that the average length can be measured by incinerating a part of the resin composition, the pellet, or the molded article by an electric furnace in air at 600° C. for 2 hours, and then observing combustion residues by a microscope and the like.

The surface of the glass filler is preferably treated with a coupling agent in order that the glass filler may show an increased affinity for the aromatic PC resin as the component (A), adhesiveness between the glass filler and the resin may be improved, and reductions in transparency and strength of the molded article due to the formation of voids in the glass filler may be suppressed. A silane-based coupling agent, a borane-based coupling agent, an aluminate-based coupling agent, a titanate-based coupling agent, or the like can be used as the coupling agent. The silane-based coupling agent is particularly preferably used because adhesiveness between the aromatic PC resin and the glass filler can be improved.

Specific examples of the silane-based coupling agent include triethoxy silane, vinyltris(β-methoxyethoxy)silane, γ-methacryloxypropyl trimethoxy silane, γ-glycidoxypropyl trimethoxy silane, β-(1,1-epoxycylohexyl)ethyltrimethoxy silane, β-(3,4-epoxycyclohexyl)ethyl trimethoxy silane, N-β-(aminoethyl)-γ-aminopropyl trimethoxy silane, N-β-(aminoethyl)-γ-aminopropylmethyl dimethoxyl silane, γ-aminopropyl triethoxy silane, N-phenyl-γ-aminopropyl trimethoxy silane, γ-mercaptopropyl trimethoxy silane, γ-chloropropyl trimethoxy silane, γ-aminopropyl trimethoxy silane, γ-aminopropyl tris(2-methoxy-ethoxy)silane, N-methyl-γ-aminopropyl trimethoxy silane, N-vinylbenzyl-γ-aminopropyl triethoxy silane, triaminopropyl trimethoxy silane, 3-ureidepropyl trimethoxy silane, 3-(4,5-dihydroimidazolyl)propyl triethoxy silane, hexamethyl disilazane, N,O-(bistrimethylsilyl)amide, and N,N-bis(trimethylsilyl)urea. Of those, preferred are aminosilanes and epoxy silanes such as γ-aminopropyl trimethoxy silane, N-β-(aminoethyl)-γ-aminopropyl trimethoxy silane, γ-glycidoxypropyl trimethoxy silane, and β-(3,4-epoxycyclohexyl)ethyl trimethoxy silane.

The surface of the glass filler can be treated with such a coupling agent by a publicly known method without any particular limitation. The surface treatment can be performed by an appropriate method depending on the shape of the glass filler; examples of the method include a sizing treatment method involving applying a solution or suspension of the above coupling agent in an organic solvent as the so-called sizing agent to the glass filler, a dry mixing method involving the use of a Henschel mixer, a Super mixer, a Redige mixer, a V-type blender, or the like, a spray method, an integral blend method, and a dry concentrate method. The surface treatment is desirably performed by the sizing treatment method, the dry mixing method, or the spray method.

The PC resin composition of the present invention must contain the aromatic PC resin as the component (A) in an amount of more than 90 parts by mass to 99 parts by mass or less and the glass filler as the component (B) in an amount of 1 part by mass or more to less than 10 parts by mass, and preferably component (A) is in an amount of 92 to 98 parts by mass and component (B) is in an amount of 2 to 8 parts by mass with respect to 100 parts by mass of the total amount of both components.

When the content of the component (B) is less than 1 part by mass, an improved effect of rigidity of the PC resin composition cannot be observed, and when the content is 10 parts by mass or more, the difference in brightness between the left half and the right half of the weld line becomes visually observable, and hence both cases are not preferred.

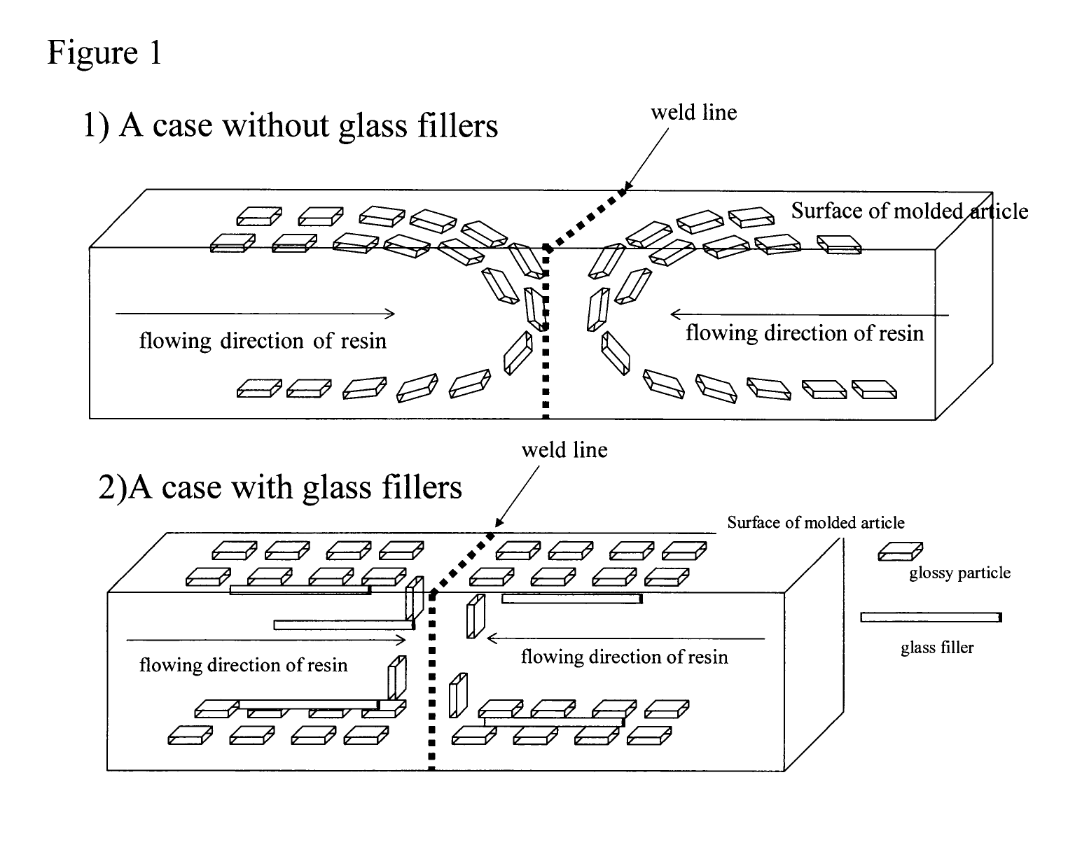

In the present invention, the reason why the difference in brightness between the left half and the right half of the weld line of a molded product is not visually observed by limiting the content of the glass filler within the specific range is described by using FIG. 1.

FIG. 1—(2) shows a state of glossy particles in the case where the glass fillers are contained in the resin composition, as in the present invention.

That is, in the case of the present invention, even when the resin compositions are flowed from left and right sides to be merged into each other and the weld line is formed at the central part, the glass fillers flow in parallel to the flowing direction of the resin compositions, the action of which inhibits the alignment of the glossy particles, the glossy particles also flows parallel to the flowing direction of the glass fillers, and thus, the glossy particles in the standing state at the left and right halves of the weld line are hardly present. Accordingly, in the present invention, light reflection by the glossy particles is approximately uniform when the left and right halves of the weld line are observed, and hence the difference in brightness is not visually observed.

Examples of the glossy particles as the component (C) in the PC resin composition of the present invention include mica, metal particles, metal sulfide particles, particles each having a surface coated with a metal or a metal oxide, and glass flakes each having a surface coated with a metal or a metal oxide.

Specific examples of the metal particles include metal powders each made of, for example, aluminum, gold, silver, copper, nickel, titanium, or stainless steel. Specific examples of the particles each having a surface coated with a metal or a metal oxide include metal oxide coating mica-based particles such as mica-titanium coated with titanium oxide and mica coated with bismuth trichloride. Specific examples of the metal sulfide particles include metal sulfide powders each made of, for example, nickel sulfide, cobalt sulfide, or manganese sulfide. A metal used in each of the glass flakes each having a surface coated with a metal or a metal oxide is, for example, gold, silver, platinum, palladium, nickel, copper, chromium, tin, titanium, or silicon.

The glossy particles as the component (C) preferably have a volume average particle diameter of about 10 to 300 μm.

The above glossy particles as the component (C) are blended in an amount of 0.01 to 3 parts by mass, or preferably 0.3 to 1.5 part by mass with respect to 100 parts by mass of the composition composed of the component (A) and component (B). When the blending amount of the component (C) is 0.01 part by mass or more, a galactic appearance or a metallic appearance is formed, and when the blending amount is 3.0 parts by mass or less, the amount of the glossy particles themselves being floated out on the surface of the PC resin composition is prevented from becoming too large, the appearance is not impaired, and flame retardancy of the PC resin composition is prevented from being decreased.

The silicone compound having a reactive functional group is further added as the component (D) to the PC resin composition of the present invention for the purpose of, for example, an additional improvement in flame retardancy of the composition.

Examples of the silicone compound having a reactive functional (hereinafter, occasionally referred to as “reactive functional group-containing silicone compound”) include polyorganosiloxane polymers and/or copolymers each having a basic structure represented by a general formula (1).

R¹ₐR²_{b}SiO_{{4-a-b}/2} (1)

In the general formula (I), R¹ represents a reactive functional group. Examples of the reactive functional group include an alkoxy group, an aryloxy group, a polyoxyalkylene group, a hydrogen group, a hydroxy group, a carboxy group, a silanol group, an amino group, a marcapto group, an epoxy group, and a vinyl group. Of those, preferred are the alkoxy group, the hydroxy group, the hydrogen group, the epoxy group, and the vinyl group.

R² represents a hydrocarbon group having 1 to 12 carbon atoms. Examples of the hydrocarbon group include a linear or branched alkyl group having 1 to 12 carbon atoms, a cycloalkyl group having 5 to 12 carbon atoms, an aryl group having 6 to 12 carbon atoms, and an aralkyl group having 7 to 12 carbon atoms. Specific examples thereof include a methyl group, an ethyl group, an n-propyl group, an isopropyl group, various butyl groups, various pentyl groups, various hexyl groups, various octyl groups, a cyclopentyl group, a cyclohexyl group, a phenyl group, a tolyl group, a xylyl group, a benzyl group, and a phenetyl group.

a and b represent a number satisfying relationships of 0<a≦3, 0<b≦3, and 0<a+b≦3. When multiple R¹'s are present, the multiple R¹'s may be the same or different from one another. When multiple R²'s are present, the multiple R²'s may be the same or different from one another.

In the present invention, polyorganosiloxane polymers and/or copolymers each having multiple reactive functional groups of the same kind, and polyorganosiloxane polymers and/or copolymers each having multiple reactive functional groups of different kinds can be used in combination.

The polyorganosiloxane polymers and/or copolymers each having the basic structure represented by the general formula (1) each have a ratio of the number of its reactive functional groups (R¹) to the number of its hydrocarbon groups (R²) of typically about 0.1 to 3, or preferably about 0.3 to 2.

Such a reactive functional group-containing silicone compound, which is a liquid, powder, or the like, preferably shows good dispersibility in melting and mixing. A liquid compound having a viscosity at room temperature of about 10 to 500,000 mm²/s can be exemplified.

The PC resin composition of the present invention has the following characteristics: even when the reactive functional group-containing silicone compound is a liquid, the compound is uniformly dispersed in the composition, and bleeds at the time of molding or to the surface of the molded article to a small extent.

The reactive functional group-containing silicone compound as the component (D) must be incorporated into the PC resin composition of the present invention at a content of 0.05 to 2.0 parts by mass with respect to 100 parts by mass of the composition composed of the component (A) and the component (B).

When the content of the component (D) is less than 0.05 part by mass, a preventing effect on dripping at the time of the combustion of the composition is insufficient. In addition, when the content exceeds 2.0 parts by mass, a screw starts to slide at the time of the kneading of the raw materials for the composition, so the raw materials cannot be successfully fed, and the ability of an apparatus including the screw to produce the composition reduces. The content of the component (D) is preferably 0.1 to 1.0 part by mass, or more preferably 0.2 to 0.8 part by mass from the viewpoints of the prevention of the dripping and productivity. Further, the reactive functional group-containing silicone compound has a refractive index of 1.45 to 1.65 and preferably 1.48 to 1.60 in order to maintain the translucency of the PC resin composition at the time of adding the silicone compound thereto.

The colorant as the component (E) which is added to the PC resin composition if required is desirably free of opacifying property, and examples of the colorant include a methine-based dye, a pyrazolone-based dye, a perinone-based dye, an azo-based dye, a quinophthalone-based dye, and an anthraquinone-based dye.

The blending amount of the colorant as the component (E) is preferably 0.0001 to 1.0 part by mass and more preferably 0.3 to 1.0 part by mass with respect to 100 parts by mass of the composition composed of the aromatic PC resin as the component (A) and the glass filler as the component (B). When the blending amount is 0.0001 part by mass or more, the PC resin composition can obtain a desired color tone, and when the blending amount is 1.0 part by mass or less, the opacifying property of the colorant is strengthened, so the metallic or galactic appearance of the PC resin composition is prevented from being impaired.

In addition to the components, an antioxidant, a UV absorbent, a release agent, an antistatic agent, a fluorescent bleach, a silane coupling agent (when the surface of the glass filler is treated by the dry mixing method), and the like can be appropriately incorporated into the PC resin composition of the present invention as required to such an extent that the object of the present invention is not impaired.

As an antioxidant, phenol-based antioxidants and phosphorous-based antioxidants are preferably used.

Examples of the phenol-based antioxidants include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis (3,5-di-tert-butyl-4-hydroxy-hydrocinnamide), 3,5-di-tert-butyl-4-hydroxy-benzylphosphonate diethyl ester, tris(3,5-di-tert-butyl-4-hydroxybenzyl)isocyanurate, and 3,9-bis{1,1-dimethyl-2-[β-(3-tert-butyl-4-hydroxy-5-methylphenyl)propionyloxy]ethyl}-2,4,8,10-tetraoxaspiro(5,5)undecane.

Examples of the phosphorous-based antioxidants include triphenylphosphite, trisnonylphenylphosphite, tris(2,4-di-tert-butylphenyl)phosphite, tridecylphosphite, trioctylphopshite, trioctadecylphosphite, didecylmonophenyl phosphite, dioctylmonophenyl phosphite, diisopropylmonophenyl phosphite, momobutyldiphenyl phosphite, monodecyldiphenyl phosphite, monooctyldiphenyl phosphite, bis(2,6-di-tert-butyl-4-methylphenyl)pentaerythritol diphosphite, 2,2-methylenebis(4,6-di-tert-butylphenyl)octyl phosphite, bis(nonylphenyl)pentaerythritol diphosphite, bis(2,4-di-tert-butylphenyl)pentaerythritol diphosphite, and distearyl pentaerythritol diphosphite.

One kind of those antioxidants may be used alone, or two or more kinds of them may be used in combination. Such an antioxidant is typically added in an amount of about 0.05 to 1.0 part by mass with respect to 100 parts by mass of the composition composed of the aromatic PC resin as the component (A) and the glass filler as the component (B).

As the UV absorbent, benzotriazole-based UV absorbent, triazine-based UV absorbent, benzooxazine-based UV absorbent, and benzophenone-based UV absorbent may be used.

Examples of the benzotriazole-based UV absorbent include 2-(2′-hydroxy-5′-methylphenyl)benzotriazole, 2-(2′-hydroxy-3′-(3,4,5,6-tetrahydrophthalimide methyl)-5′-methyphenyl)benzotriazole, 2-(2′-hydroxy-3′,5′-di-tert-butylphenyl)benzotriazole, 2-(2′-hydroxy-5′-tert-octylphenyl)benzotriazole, 2-(3′-tert-butyl-5′-methyl-2′-hydroxyphenyl)-5-chlorobenzotriazole, 2,2′-methylenebis(4-(1,1,3,3-tetramethylbutyl)-6-(2H-benzotriazole-2-yl)phenol), 2-(2′-hydroxy-3′5′-bis (α,α-dimethylbenzyl)phenyl)-2H-benzotriazole, 2-(3′,5′-di-tert-amyl-2′-hydroxyphenyl)benzotriazole, and 5-trifluoromethyl-2-(2-hydroxy-3-(4-methoxy-a-cumyl)-5-tert-butylphenyl)-2H-benzotriazole.

Of those, 2-(2′-hydroxy-5′-tert-octylphenyl)benzotriazole is preferred.

As the triazine-based UV absorbent, TINUVIN 400 (trade name, manufactured by Ciba Specialty Chemicals Inc.) which is a hydroxyphenyl triazine-based UV absorbent is preferred.

Examples of the benzooxazine-based UV absorbent include 2-methyl-3,1-benzooxazine-4-one, 2-butyl-3,1-benzooxazine-4-one, 2-phenyl-3,1-benzooxazine-4-one, 2-(1- or 2-naphthyl)-3,1-benzooxazine-4-one, 2-(4-biphenyl)-3,1-benzooxazine-4-one, 2,2′-bis(3,1-benzooxazine-4-one), 2,2′-p-phenylenebis(3,1-benzooxazine-4-one), 2,2′-m-phenylenebis (3,1-benzooxazine-4-one), 2,2′-(4,4′-diphenylene)bis(3,1-benzooxazine-4-one), 2,2′-(2,6- or 1,5-naphthalene)bis(3,1-benzooxazine-4-one), and 1,3,5-tris (3,1-benzooxazine-4-one-2-yl)benzene.

Of those, 2,2′-p-phenylenebis(3,1-benzooxazine-4-one) is preferred.

Examples of the benzophenone-based UV absorbent include 2-hydroxy-4-methoxy benzophenone, 2-hydroxy-4-n-octoxybenzophenone, 2-hydroxy-4-methoxy-2′-carboxybenzophenone, 2,4-dihydroxybenzophenone, and 2,2′-dihydroxy-4-methoxy benzophenone. Of those, 2-hydroxy-4-n-octoxybenzophenone is preferred.

One kind of those UV absorbents may be used alone, or two or more kinds of them may be used in combination. Such a UV absorbent is typically added in an amount of about 0.05 to 2.0 parts by mass with respect to 100 parts by mass of the composition composed of the component (A) and the component (B).

A higher fatty acid ester of a monohydric or polyhydric alcohol can be used as the release agent. Such a higher fatty acid ester is preferably a partial or complete ester of a monohydric or polyhydric alcohol having 1 to 20 carbon atoms and a saturated fatty acid having 10 to 30 carbon atoms. Examples of the partial ester or the complete ester of a monohydric or polyhydric alcohol and the saturated fatty acid include monoglyceride stearate, monosorbitate stearate, monoglyceride behenate, pentaerythritol monostearate, pentaerythritol tetrastearate, propyleneglycol monostearate, stearylstearate, palmitylpalmitate, butyl stearate, methyl laurate, isopropyl palmitate, and 2-ethylhexyl stearate. Of those, monoglyceride stearate and pentaerythritol tetrastearate are preferably used.

One kind of those release agents may be used alone, or two or more kinds of them may be used in combination. Such a release agent is typically added in an amount of about 0.1 to 5.0 part by mass with respect to 100 parts by mass of the composition composed of the component (A) and the component (B).

As the antistatic agent, for example, a monoglyceride of the fatty acid having 14 to 30 carbon atoms, and more specifically, monoglyceride stearate, monoglyceride palmitate, or a polyamide polyether block copolymer may be used.

As the fluorescent bleach, for example, stilbene-based, benzoimidazole-based, naphthalimide-based, rhodamine-based, coumarin-based, and oxazine-based compounds are exemplified. More specifically, commercially-available products such as UVITEX (trade name, manufactured by Ciba Specialty Chemicals Inc.), OB-1 (trade name, manufactured by Eastman Co.), TBO (trade name, manufactured by SUMITOMO SEIKA CHEMICALS CO. LTD.), Keikol (trade name, manufactured by NIPPON SODA CO. LTD.), Kayalight (trade name, manufactured by NIPPON KAYAKU CO. LTD.), and Leucophor EGM (trade name, manufactured by Clariant Japan) may be used.

It is to be noted that the compounds exemplified above can be used as a silane coupling agent.

A method of preparing the PC resin composition of the present invention is not particularly limited, and a conventionally known method can be applied. To be specific, the composition can be prepared by: blending the aromatic PC resin, which is a copolymer of the general PC resin (a-1) and the PC-POS (a-2), as the component (A), the glass filler as the component (B), the glossy particles as the component (C), the reactive functional group-containing silicone compound as the component (D), the colorant as the component (E) which may be added where necessary, and the above various optional components at a predetermined ratio; and kneading the mixture.

The blending and the kneading are performed by preliminarily mixing the compounds using commonly used devices such as a ribbon blender and a drum tumbler, and using a Henschel mixer, a Banbury mixer, a single-screw extruder, a twin-screw extruder, a multi-screw extruder, and a cokneader. Heating temperature in melt-kneading is appropriately selected generally from a range of about 240 to 300° C.

It is to be noted that any component to be incorporated other than the aromatic PC resin can be melted and kneaded with part of the aromatic PC resin in advance before being added: the component can be added as a master batch.

The PC resin composition of the present invention thus-prepared has a flame retardancy determined by evaluation for flame retardancy in conformance with UL94 of 1.5 mmV-0, so the composition has excellent flame retardancy. It is to be noted that a flame retardancy evaluation test is described later.

Hereinafter, a PC resin molded article of the present invention is described.

The PC resin molded article of the present invention is obtained by molding the above-mentioned PC resin composition of the present invention using an injection molding method or the like. Upon molding, the thickness of the PC molded article is preferably about 0.3 to 10 mm, and is appropriately selected from the range depending on an application of the molded article.

A method for producing the PC resin molded article of the present invention is not particularly limited, and any one of the various conventionally known molding methods such as an injection molding method, an injection compression molding method, an extrusion molding method, a blow molding method, a press molding method, a vacuum molding method, and a foam molding method can be employed; injection molding at a mold temperature of 120° C. or higher is particularly preferable. In this case, a resin temperature in the injection molding is typically about 240 to 300° C., or preferably 260 to 280° C.

Injection molding at a mold temperature of 120° C. or higher, provides, for example, the following merit: the glass filler sinks, so the molded article can obtain a good appearance. The mold temperature is more preferably 125° C. or higher and 140° C. or lower, or still more preferably 130° C. to 140° C.

The PC resin composition of the present invention as a molding raw material is preferably pelletized by the melting kneading method before being used. It is to be noted that gas injection molding for the prevention of sink marks in the appearance of the molded article or for a reduction in weight of the molded article can be applied as an injection molding method.

In the thus obtained PC resin molded article of the present invention, even when a weld line is formed, difference in brightness between the left half and the right half of the weld line is not visually observed, and a good metallic appearance or a galactic appearance can be obtained on the entire surface of the molded article.

It is to be noted that a method for measuring the difference in brightness between the left half and the right half of the weld line is described later.

In addition, the present invention provides a method for producing a PC resin molded article characterized by including subjecting the above-mentioned PC resin composition of the present invention to injection molding at a mold temperature of 120° C. or higher, or preferably 120 to 140° C. to produce a molded article having a thickness of preferably 0.3 to 10 mm.

The PC resin composition of the present invention contains the glass filler or glossy particle having a refractive index equal or close to that of the aromatic PC resin, is excellent in, for example, transparency, mechanical strength, impact resistance, and heat resistance, and is provided with high flame retardancy because it contains a silicone compound having a reactive functional group. In addition to having a metallic appearance or galactic appearance, the PC resin molded article of the present invention obtained by using the composition is excellent in, for example, transparency, flame retardancy, mechanical strength, impact resistance, and heat resistance.

The PC resin molded article of the present invention is preferably used for the following items, for example:

(1) various parts of televisions, radio cassettes, video cameras, video tape recorders, audio players, DVD players, air conditioners, cellular phones, displays, computers, resistors, electric calculators, copiers, printers, and facsimiles, and electrical/electronic device parts such as outside plates and housing materials;
(2) parts for precision machinery such as cases and covers for precision machines such as PDA's, cameras, slide projectors, clocks, gauges, display instruments;
(3) parts for automobiles such as automobile interior materials, exterior products, and automobile body parts including instrument panels, upper garnishes, radiator grills, speaker grills, wheel covers, sunroofs, headlamp reflectors, door visors, spoilers, rear windows, and side windows; and
(4) parts for furniture such as chairs, tables, desks, blinds, lighting covers, and interior instruments.

### EXAMPLES

Hereinafter, the present invention is described in more detail by way of examples and comparative examples, but the present invention is not limited thereto.

It is to be noted that a test piece was molded out of a PC resin composition pellet obtained in each examples and comparative examples as described below, and was evaluated for various characteristics.

(1) Glass Fiber Length

Several grams of the PC resin composition pellet were measured and placed in a SiO₂/Al₂O₃ crucible, and were baked by a muffle furnace FP-21 manufactured by Yamato Scientific Co. Ltd. in air at 600° C. for 2 hours. Thereafter, a part of the combustion residues was sandwiched by slide glasses, to thereby observe a fiber length of the pellet by a universal projector V-24B manufactured by Nippon Kogaku K.K. In one measurement, 200 fibers were measured for their lengths and the average thereof was determined. The measurement was performed three times per one sample, and the average thereof was taken as the average fiber length.

(2) Mechanical Characteristics

A PC resin composition pellet was subjected to injection molding with a 100-ton injection molding machine [manufactured by TOSHIBA MACHINE CO. LTD., machine name “IS100E”] at a mold temperature of 130° C. and a resin temperature of 280° C., whereby respective test pieces each having a predetermined form were produced.

The deflection temperature under load of each test piece was measured in conformance with ASTM D648, and the obtained temperature was used as the index of heat resistance. The specific gravity of the test piece was measured in conformance with ASTM D792.

(3) Optical Characteristics (Glossy Particles with or without Alignment)

The PC resin composition pellet was subjected to injection molding with a mold having two-point-gate by using a 100-ton injection molding machine [manufactured by Sumitomo Heavy Industries, Ltd., machine name “SG100M-HP”] at a mold temperature of 130° C., whereby a test piece having a weld line and having 80×80×2 mm was produced. The thus obtained test piece was irradiated with daylight in an oblique direction of 45° and was determined whether the difference in brightness of the glossy particles between the left half and the right half of the weld line could be visually observed.

(4) Appearance

The appearance of a surface of the test piece used for the measurement of the optical characteristics was visually observed, and was distinguished by determining whether the test piece has a galactic appearance, which is an object of the present invention, or not (marble tone in appearance).

(5) Flame Retardancy

The PC resin composition pellet was subjected to injection molding by using a 45-ton injection molding machine [manufactured by TOSHIBA MACHINE CO. LTD., machine name “IS45PV”] at a mold temperature of 130° C. and a resin temperature of 280° C., whereby a test piece having 127×12.7>1.5 mm was produced. The flame retardancy of the test piece was measured in conformance with UL94 (Underwriters Laboratories Subject 94).

The kinds of the respective components used in the production of each PC resin composition pellet are shown below.

(1) PC1 [component (A)]: a bisphenol A polycarbonate having a viscosity average molecular weight of 19,000 [manufactured by Idemitsu Kosan Co. Ltd., trade name “TARFLON FN1900A”, refractive index 1.585]
(2) PC2 [component (A)]: a PC-POS copolymerized resin having a viscosity average molecular weight of 15,000, containing 4% by mass of POS, chain length (n) of POS of 30, refractive index 1.584.
(3) Refractive index-improved GF1 [component (B)]; glass fibers each composed of a chopped strand having φ 13 μm×3 mm [manufactured by ASAHI FIBER GLASS Co. Ltd., glass composition (% by mass): SiO₂ (52.6), Al₂O₃ (13.3), CaO (21.8), TiO₂ (5.9), B₂O₃ (5.9), MgO (0.5), refractive index 1.585, specific gravity 2.70]
(4) Refractive index-improved GF2 [component (B)]; glass fibers each composed of a chopped strand having φ 13 μm×3 mm [manufactured by ASAHI FIBER GLASS Co. Ltd., glass composition (% by mass): SiO₂ (57.5), Al₂O₃ (12.0), CaO (21.0), TiO₂ (5.0), MgO (2.5), ZnO (1.5), Na₂O+K₂O+L+i₂O (0.5), refractive index 1.584, specific gravity 2.69]
(5) GF1 [for comparison with component (B)]: glass fibers each composed of chopped strand (φ 13 μm×3 mm) made of E glass [manufactured by ASAHI FIBER GLASS Co. Ltd., trade name “03MA409C”, glass composition (% by mass): SiO₂ (55.4), Al₂O₃ (14.1), CaO (23.2), B₂O₃ (6.0), MgO (0.4), Na₂O+K₂O+LiO₂ (0.7), Fe₂O₃ (0.2), F₂ (0.6), refractive index 1.555, specific gravity 2.54]
(6) GF2 [for comparison with component (B)]: glass fibers each composed of chopped strand (φ 13 μm×3 mm) made of ECR glass [manufactured by ASAHI FIBER GLASS Co. Ltd., glass composition (% by mass): SiO₂ (58.0), Al₂O₃ (11.4), CaO (22.0), TiO₂ (2.2), MgO (2.7), ZnO (2.7), Na₂O+K₂O+LiO₂ (0.8), Fe₂O₃ (0.2), refractive index 1.579, specific gravity 2.72]
(7) Glossy particle 1 [Component (C)]: a glass flake coated with titanium oxide [manufactured by NIPPON SHEET GLASS Co. Ltd., trade name “MC1030RS”]
(8) Glossy particle 2 [Component (C)]: a glass flake coated with titanium oxide and silicon oxide [manufactured by MERCK Ltd., Japan, trade name “Miraval 15411”]
(9) Glossy particle 3 [Component (C)]: aluminum foil coated with a coloring material [manufactured by Nihonboshitsu Co. Ltd., trade name “ASTROFLAKE”]
(10) Flame retardant assistant 1 [Component (D)]: reactive silicone compound having a refractive index of 1.51 and containing a vinyl group and a methoxy group as functional groups [manufactured by Shin-Etsu Chemical Co. Ltd.], trade name “KR-219”]
(11) Flame retardant assistant 2 [Component (D)]: reactive silicone compound having a refractive index of 1.49 and containing a vinyl group and a methoxy group as functional groups [manufactured by Dow Corning Toray Co. Ltd.], trade name “DC3037”]
(12) Flame retardant assistant 3 [for comparison with component (D)]: polytetrafluoroethylene resin [manufactured by Asahi-ICI Fluoropolymers Co. Ltd.], trade name “CD076”]
(13) Colorant 1 [Component (E)]: anthraquinone-based orange dye [manufactured by Mitsubishi Chemical Corporation, trade name “Dia Resin Orange HS”]
(14) Colorant 2 [Component (E)]: anthraquinone-based green dye [manufactured by Sumitomo Chemical Co. Ltd., trade name “Sumiplast green G”]
(15) Release agent 1: pentaerythritol tetrastearate [manufactured by RIKEN VITAMIN CO. LTD., trade name “EW440A”]
(16) Stabilizer 1: antioxidant [octadecyl3-(3,5-di-tert-butyl-4-hydroxyphenyl)propionate, manufactured by Ciba Specialty Chemicals Inc., trade name “Irganox 1076”]
(17) Stabilizer 2: antioxidant [tris(2,4-di-tert-butylphenyl)phosphite, manufactured by Ciba Specialty Chemicals Inc., trade name “Irgafos 168”]

### Examples 1 to 7 and Comparative Examples 1 to 7

In each of the examples and the comparative examples, the respective components were mixed at a blending ratio shown in Table 1, and the mixture was melted and kneaded with a biaxial extruder [manufactured by TOSHIBA MACHINE CO. LTD., machine name “TEM-35B”] at 280° C., whereby a PC resin composition pellet was produced. A test piece was molded out of each pellet as described above, and its physical characteristics, optical characteristics, and flame retardancy were determined. Table 1 shows the results.

TABLE 1

| | | Example | | | | | | | Comparative Example | | | | | | |
|---|---|---|---|---|---|---|---|---|---|---|---|---|---|---|---|
| | | 1 | 2 | 3 | 4 | 5 | 6 | 7 | 1 | 2 | 3 | 4 | 5 | 6 | 7 |
| Composition | PC1 (refractive index: 1.585) | 73.5 | 72.75 | 71.25 | 69 | 73.5 | 71.25 | 73.5 | 75 | 60 | 74.625 | 73.5 | 73.5 | 71.25 | 71.25 |
| [part (s) by mass] | [component (A)] | | | | | | | | | | | | | | |
| | PC2 (refractive index: 1.584) | 24.5 | 24.25 | 23.75 | 23 | 24.5 | 23.75 | 24.5 | 25 | 20 | 24.875 | 24.5 | 24.5 | 23.75 | 23.75 |
| | [component (A)] | | | | | | | | | | | | | | |
| | Refractive index-improved | | | | | | 5 | | | 20 | 0.5 | | 2 | | |
| | GF1 (refractive index: 1.585) | | | | | | | | | | | | | | |
| | [component (B)] | | | | | | | | | | | | | | |
| | Refractive index-improved | 2 | 3 | 5 | 8 | 2 | | 2 | | | | 2 | | | |
| | GF2 (refractive index: 1.584) | | | | | | | | | | | | | | |
| | [component (B)] | | | | | | | | | | | | | | |
| | GF 1 for comparison | | | | | | | | | | | | | 5 | |
| | (refractive index: 1.555) | | | | | | | | | | | | | | |
| | [for comparison | | | | | | | | | | | | | | |
| | with component (B)] | | | | | | | | | | | | | | |
| | GF 2 for comparison | | | | | | | | | | | | | | 5 |
| | (refractive index: 1.579) | | | | | | | | | | | | | | |
| | [for comparison | | | | | | | | | | | | | | |
| | with component (B)] | | | | | | | | | | | | | | |
| | Glossy particle 1 [component | 0.3 | 0.5 | 1 | 1 | | | 0.3 | 2 | 2 | 2 | 2 | 5 | 1 | 1 |
| | (C)] | | | | | | | | | | | | | | |
| | Glossy particle 2 [component | | | | | 0.8 | | 0.3 | | | | | | | |
| | (C)] | | | | | | | | | | | | | | |
| | Glossy particle 3 [component | | | | | | 2 | | | | | | | | |
| | (C)] | | | | | | | | | | | | | | |
| | Flame retardant assistant 1 | 0.6 | | 0.6 | 0.6 | 0.6 | 0.6 | 0.6 | 0.3 | 0.3 | 0.3 | | 0.6 | 0.6 | 0.6 |
| | [Component (D)] | | | | | | | | | | | | | | |
| | Flame retardant assistant 2 | | 1.0 | | | | | | | | | | | | |
| | [Component (D)] | | | | | | | | | | | | | | |
| | Flame retardant assistant | | | | | | | | | | | 0.3 | | | |
| | 3 [for comparison with | | | | | | | | | | | | | | |
| | component (D)] | | | | | | | | | | | | | | |
| | Colorant l [component (E)] | 0.1 | 0.1 | 0.1 | 0.1 | 0.1 | 0.1 | 0.1 | 0.1 | 0.1 | 0.1 | 0.1 | 1 | 0.1 | 0.1 |
| | Colorant 2 [component (E)] | 0.3 | 0.3 | 0.3 | 0.3 | 0.3 | 0.3 | 0.3 | 0.3 | 0.3 | 0.3 | 0.3 | 3 | 0.3 | 0.3 |
| | Release agent 1 | 0.8 | 0.8 | 0.8 | 0.8 | 0.8 | 0.8 | 0.8 | 0.8 | 0.8 | 0.8 | 0.8 | 0.8 | 0.8 | 0.8 |
| | Stabilizer 1 | 0.1 | 0.1 | 0.1 | 0.1 | 0.1 | 0.1 | 0.1 | 0.1 | 0.1 | 0.1 | 0.1 | 0.1 | 0.1 | 0.1 |
| | Stabilizer 2 | 0.1 | 0.1 | 0.1 | 0.1 | 0.1 | 0.1 | 0.1 | 0.1 | 0.1 | 0.1 | 0.1 | 0.1 | 0.1 | 0.1 |
| Average fiber length in pellet (μm) | | 350 | 380 | 400 | 400 | 350 | 400 | 350 | — | 400 | 350 | 350 | 350 | 400 | 400 |
| Mechanical | Deflection temperature | 128 | 128 | 131 | 138 | 128 | 131 | 128 | 144 | 144 | 141 | 126 | 128 | 131 | 131 |
| characteristics | under load (° C.) | | | | | | | | | | | | | | |
| | Specific gravity | 1.21 | 1.22 | 1.24 | 1.26 | 1.21 | 1.24 | 1.21 | 1.33 | 1.33 | 1.30 | 1.20 | 1.21 | 1.24 | 1.24 |
| Optical | Difference in brightness | Not | Not | Not | Not | Not | Not | Not | Visually | Visually | Visually | Not | Visually | Not | Not |
| characteristics | between left half and right | visually | visually | visually | visually | visually | visually | visually | observable | observable | observable | visually | observable | visually | visually |
| | half of weld line (glossy | observable | observable | observable | observable | observable | observable | observable | | | | observable | | observable | observable |
| | particle with alignment) | | | | | | | | | | | | | | |
| | Appearance | Glactic | Glactic | Glactic | Glactic | Glactic | Glactic | Glactic | Glactic | Glactic | Glactic | Marble | Glactic | Marble | Marble |
| | | tone | tone | tone | tone | tone | tone | tone | tone | tone | tone | tone | tone | tone | tone |
| Flame retardancy | UL-94 | V-0 | V-0 | V-0 | V-0 | V-0 | V-0 | V-0 | V-2 | V-0 | V-0 | V-0 | V-1 | V-0 | V-0 |
| | Test piece thickness: 1.5 mm | | | | | | | | | | | | | | |

From Table 1, the following are confirmed.

As is apparent from respective examples, the molded article can be obtained, in which the difference in brightness between the left half and the right half of the weld line is not visually observed and a good galactic appearance is provided, by molding the PC resin composition obtained by blending predetermined amounts of the aromatic PC resin and the PC-POS copolymer resin, a predetermined amount of the glass filler having difference in a refractive index of 0.002 or less from the PC resin, and predetermined amounts of the glossy particles and the silicone compound having a reactive functional group. The molded article can be further provided with excellent flame retardancy, while maintaining strength and heat resistance.

Further, the following are found from Table 1.

As is apparent from Comparative Example 1, in the case where the glass filler is not added to the PC resin composition, the difference in brightness between the left half and the right half of the weld line is visually observed.

As is apparent from Comparative Examples 2 and 3, even in the molded article obtained from the resin composition composed of the aromatic PC resin and the PC-POS copolymer resin, the glass filler having difference in a refractive index of 0.002 or less from the PC resin, the glossy particles, and the silicone compound having a reactive functional group, when the blending amount of the glass filler exceeds the range specified in the present invention, the specific gravity becomes large and the difference in brightness between the left half and the right half of the weld line is visually observed in the case of Comparative Example 2, and, in the case of Comparative Example 3, the specific gravity does not become large, but the difference in brightness between the left half and the right half of the weld line is visually observed.

As is apparent from Comparative Example 4, in the molded article obtained from the resin composition to which flame retardant assistant 3 is added, the appearance is a marble tone, and the polycarbonate resin molded article having an excellent galactic appearance or metallic appearance, which is an object of the present invention, cannot be obtained, although there is no problem in the other characteristics.

As is apparent from Comparative Example 5, even in the molded article obtained from the resin composition composed of the aromatic PC resin and the PC-POS copolymer resin, the glass filler having difference in a refractive index of 0.002 or less from the PC resin, the glossy particles, and the silicone compound having a reactive functional group, when the blending amount of the glossy particles exceeds the range specified in the present invention, flame retardancy is poor and the difference in brightness between the left half and the right half of the weld line can be visually observed.

As is apparent from Comparative Examples 6 and 7, in the molded article obtained from the resin composition composed of the aromatic PC resin and the PC-POS copolymer resin, the glass filler made of the E glass (refractive index: 1.555) or the ECR glass (refractive index: 1.579), each of which has a refractive index smaller or larger than a refractive index of the PC resin by more than 0.002, the glossy particles, and the silicone compound having a reactive functional group, flame retardancy can be maintained, but the surface pattern is a marble tone and cannot be provided with a galactic appearance.

### INDUSTRIAL APPLICABILITY

The PC resin composition of the present invention includes the aromatic PC resin, the glass filler having a refractive index same as or approximately same as a refractive index of the aromatic PC resin, the glossy particles, and the reactive silicone compound, and, by molding, as a base material, the PC resin composition which, if required, the colorant is added thereto, the difference in brightness between the left half and the right half of the weld line is not visually observed even when the weld line is formed in the molded article, and high flame retardancy is imparted thereto. The PC resin molded article of the present invention obtained by using those compositions can be suitably used for applications in various fields.

1. A polycarbonate resin composition comprising, with respect to 100 parts by mass of a composition composed of (A) more than 90 parts by mass and 99 parts by mass or less of an aromatic polycarbonate resin containing a polycarbonate-polyorganosiloxane copolymer and (B) 1 part by mass or more and less than 10 parts by mass of a glass filler having a difference in a refractive index of 0.002 or less from the aromatic polycarbonate resin, (C) 0.01 to 3.0 parts by mass of a glossy particle and (D) 0.05 to 2.0 parts by mass of a silicone compound having a reactive functional group.

2. The polycarbonate resin composition according to claim 1, wherein the aromatic polycarbonate resin as the component (A) includes 10 to 40 parts by mass of the polycarbonate-polyorganosiloxane copolymer.

3. The polycarbonate resin composition according to claim 1, wherein the polycarbonate-polyorganosiloxane copolymer includes a polyorganosiloxane moiety at a ratio of 0.3 to 5.0% by mass.

4. The polycarbonate resin composition according to claim 1, wherein the glass filler as the component (B) includes a glass fiber.

5. The polycarbonate resin composition according to claim 1, wherein the refractive index of the glass filler as the component (B) is 1.583 to 1.587.

6. The polycarbonate resin composition according to claim 1, wherein the glossy particle as the component (C) is one or two or more kinds selected from the group consisting of mica, metal particles, metal sulfide particles, particles each having a surface coated with a metal or a metal oxide, and glass flakes each having a surface coated with a metal or a metal oxide.

7. The polycarbonate resin composition according to claim 1, further including (E) 0.0001 to 1 part by mass of a colorant with respect to 100 parts by mass of the composition composed of the component (A) and the component (B).

8. A polycarbonate resin molded article obtained by molding the polycarbonate resin composition according to claim 1.

9. The polycarbonate resin molded article according to claim 8, wherein the polycarbonate resin molded article is obtained by injection molding at a mold temperature of 120° C. or higher.

10. The polycarbonate resin molded article according to claim 8, wherein the polycarbonate resin molded article has a flame retardancy determined by a flame retardancy evaluation method in conformance with UL94 of 1.5 mmV-0.

11. The polycarbonate resin molded article according to claim 8, wherein the glass filler contained in a pellet of the polycarbonate resin composition or in a molded article of the polycarbonate resin composition has an average length of 300 μm or more.

12. A method for producing a polycarbonate resin molded article, comprising subjecting the polycarbonate resin composition according to claim 1 to injection molding at a mold temperature of 120° C. or higher.
